(19) United States
(12) Patent Application Publication
(10) Pub. No.: US 2008/0178206 A1
(43) Pub. Date: Jul. 24, 2008

(54) Disk magazine and disk changer system

(75) Inventor: Tamotsu Iida, Ibaraki (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/896,884

(22) Filed: Sep. 6, 2007

(30) Foreign Application Priority Data
Sep. 8, 2006 (JP) 2006-243541

(51) Int. Cl. G11B 33/14

(52) U.S. Cl. 720/648

(57) ABSTRACT

A disk magazine accommodating therein a plurality of disks having a thickness of 0.3 mm or less and constructed to be made integral with a recording unit, in which management information including hysteresis information and inherent information of disks accommodated in the disk magazine is recorded. The management information includes, as inherent information of disks, information of a defective disk, or information of a disk pulled out from the disk magazine to be missed.

### BACKGROUND OF THE INVENTION

The present invention relates to a disk magazine, which accommodates therein disks such as optical disk recording medium, and a disk changer system, which takes out a disk from the disk magazine to perform recording and reproducing of information.

In recent years, in the field of optical disks, a substrate thickness which is optically required becomes small as optical disks become high in density, while flatness of a substrate surface is further demanded in order to ensure stability in reading information. Also, when an objective lens of an optical head is increased in NA in order to promote an increase in density, a tolerance of inclination of a substrate surface is narrowed and the necessity of taking account of crosstalk with adjacent tracks is further increased.

When a substrate is made thin, however, it is decreased in stiffness and of course liable to deform, so that it is difficult to ensure flatness for a substrate surface and a substrate surface at the time of recording and reproducing tends to be relatively increased in inclination.

By the way, methods of recording on an optical disk include one, in which laser beam is irradiated over a substrate, and one, in which a translucent cover layer is provided on an opposite surface of a substrate and recording is performed through the cover layer. In the latter method, since the cover layer can be designed to be made thin while the substrate remains thick, an objective lens being high in NA can be used, so that laser light beam can be throttled to enable recording and merchandising is achieved for high-vision picture recording. Meanwhile, there have been made efforts directed to high density taking account of compatibility with a conventional optical disk while maintaining a conventional substrate thickness. Therefore, uniformity in optical characteristic of a substrate is further demanded and realized by an improvement in production technology.

The both methods have both merits and demerits in the present state and are preserved in efforts directed to an increase in recording density but it is of course necessary to make a substrate further accurate in characteristic when taking into consideration a further increase in density.

While efforts directed to an increase in surface density for the sake of high density are continued in optical disks, efforts directed to an increase in recording density per volume are made. In order to achieve an increase in recording density for a specific volumetric space, it is necessary to promote having an optical disk recording layer multilayered, so that two layers on one surface are standardized for DVD and put into practical use for blue laser recording disks called HDDVD® and Blue-Ray®. In this case, while a substrate is required to have a thickness of 0.6 mm in terms of mechanical property, a thin optical disk becomes possible provided that a problem of mechanical property is solved since the mechanical property is not a condition needed for recording. With a thin disk, it is the state of things that care be demanded in handling of the disk because of its thinness and contrivance be also demanded in driving of the disk.

Hereupon, such thin optical disk needs a housing, which protects the disk, that is, a magazine (referred to as “cartridge” also) for the sake of storage stability and handling property. In order to efficiently accommodate a disk in a magazine, it is desirable to accommodate not a single disk but a plurality of disks collectively to make a single magazine as large as possible in recording capacity. That is, in this case, with a thin optical disk, it is desirable to handle a plurality of optical disks with a magazine as a unit.

Also, since a thin optical disk is less in mechanical stiffness and liable to deform under gravitation, a flat surface must be formed by correcting such deformation for driving the disk. In order to achieve this, there is thought of a method of correcting a posture of a disk while producing an air flow on a disk underside as driving means.

On the other hand, an important item of an optical disk in optical characteristic includes an evaluation item of a disk called birefringence or retardation. With a large birefringence, turbulence is generated in convergent ray to give rise to an obstruction in recording and reproducing characteristic. Since birefringence decreases in reverse proportion to a substrate thickness, however, such obstruction is decreased. Since the birefringence index frequently causes a problem when the recording wavelength becomes small and an optical head is increased in NA, it is important in developing the high-density technology. Also, since an optical distance through a substrate becomes small when a substrate thickness is small, inclination of an incident light (that is, tilt) has less influences. When a driving method making the best use of a feature of a thin substrate is obtained, there is a possibility that the recording density per volume can be increased. Normal DVD substrates have a thickness of 0.6 mm and an optical disk being as small in thickness as 0.3 mm or less is here examined as a thin disk. Since the mechanical stiffness is proportional to third power of a thickness, a thin disk becomes a substrate having a stiffness of one eighth of that of a single DVD substrate. In addition, a disk, in which it is necessary in driving of an optical disk to take account of drive means for ensuring flatness, is defined as a thin optical disk.

In case of mounting thin optical disks in a single magazine, an increase in mounting efficiency is achieved by mounting a plurality of disks, thus enabling an increase in recording density per volume. Respective disks as mounted are normally managed in the same manner as commercially available disks and include a system lead-in region on an inner peripheral side and a system lead-out region on an outer peripheral side like, for example, DVD-R. Respective disks are distinguished by inherent identifiers and can be specified by the identifiers.

By the way, with a conventional optical disk changer described in JP-A-2001-35057, when an optical disk is charged in a changer unit, it is once driven by a drive and specified to be accommodated in a specific shelf before the optical disk is used. This operation serves to determine the relationship between an optical disk and a shelf, in which the optical disk is accommodated, and takes time considerably. Such work of mounting an optical disk must be surely carried out before use, and is also needed to be carried out when another optical disk is added.

However, while a mounting work for a plurality of optical disks mounted in a magazine can be carried out in the same manner as described above, it is inconvenient since essential recording and reproducing operations cannot be performed during time for such work. It is desired that a usable state be brought about immediately when a magazine is mounted in a changer unit.

### SUMMARY OF THE INVENTION

The invention has been thought of in view of such situation and has its object to provide a disk magazine enabling recording and reproducing operations immediately when a magazine with a plurality of disks accommodated therein is mounted in a recording and reproducing unit such as a disk changer system, or the like, without performing a time-consuming mount work, and a disk changer system.

In order to solve the problem, the invention relates to a disk magazine, which accommodates a plurality of thin disks in one and the same magazine, and has a feature in that a storage element for recording of management information is mounted integrally with a magazine and information including management information of disks is stored in the storage element.

More specifically, the invention has a feature in a disk magazine accommodating therein a plurality of disks having a thickness of 0.3 mm or less and constructed to be made integral with a recording unit, in which management information including hysteresis information and inherent information of disks accommodated in the disk magazine is recorded. A semiconductor memory such as a RFID element can be used for the recording unit and a recording or reproducing operation of management information is performed on the recording unit through radio communication.

The invention has a feature in a disk changer system mounting thereon a disk magazine accommodating a plurality of disks to take out a disk from the disk magazine to carry out a recording/reproducing operation of information, the disk changer system comprising management information acquisition means for communication with a recording unit, in which management information of a plurality of disks accommodated in the disk magazine is recorded, to acquire the management information, and processing control means, which recognizes that a disk magazine is an inherent magazine to control a recording/reproducing operation for disks accommodated in the disk magazine. In addition, the recording unit is mounted integrally with the disk magazine.

The disk changer system further comprises a plurality of shelves capable of mounting thereon a plurality of disk magazines, and the management information acquisition means includes communication means provided on each of the plurality of shelves to communicate with a recording unit provided on the plurality of disk magazines, and relates an inherent address of a disk magazine included in the recording unit and an inherent address of a shelf set for each of the plurality of shelves to each other to recognize the plurality of disk magazines. In addition, the communication means comprises radio communication means composed of, for example, a non-contact semiconductor element and is put in an opposed relationship with the recording unit when the disk magazine is mounted. Also, preferably, the recording unit is mounted in the vicinity of a position reference of the disk magazine and in that position, in which shift in mounting of a disk magazine has no influences on the opposed relationship with the radio communication means when a disk magazine is mounted to the disk changer system.

The management information described above may include, as inherent information of disks, information of a defective disk, or information of a disk pulled out from the disk magazine to be missed, or information on a file, which is recorded across a plurality of disks.

Further features of the invention will become apparent from a best mode for carrying out the invention and the accompanying drawings.

According to the invention, it is possible to carry out recording and reproducing operations immediately when a magazine with a plurality of disks accommodated therein is mounted in a recording and reproducing unit such as a disk changer system, or the like, without performing a time-consuming mount work every disk.

### BRIEF DESCRIPTION OF THE DRAWINGS

FIG. 1 is a view showing an external construction of an optical disk magazine according to the invention;

FIG. 2 is a view showing examples, in which a nonvolatile memory (RFID element) used in the invention is arranged on a magazine;

FIG. 3 is a view showing construction of a device, by which management information included in the RFID element (identification unit) is read;

FIG. 4 is a view showing an example, in which a magazine is positioned;

FIG. 5 is a view showing an outline construction of a RFID system including a RFID element (identification unit) and its read/write unit;

FIG. 6 is a view showing an outline construction of a changer unit, in which a plurality of magazines can be mounted; and

FIG. 7 is a flowchart for illustration of a magazine access operation as an operation example in the changer unit.

### DESCRIPTION OF THE PREFERRED EMBODIMENT

Embodiments of the invention will be described with reference to the accompanying drawings. In addition, of course, the invention is not limited to the embodiments but modification, addition and substitution in construction is possible as far as it does not depart from an essential scope of the invention.

### <Construction of an Optical Disk Storage Magazine>

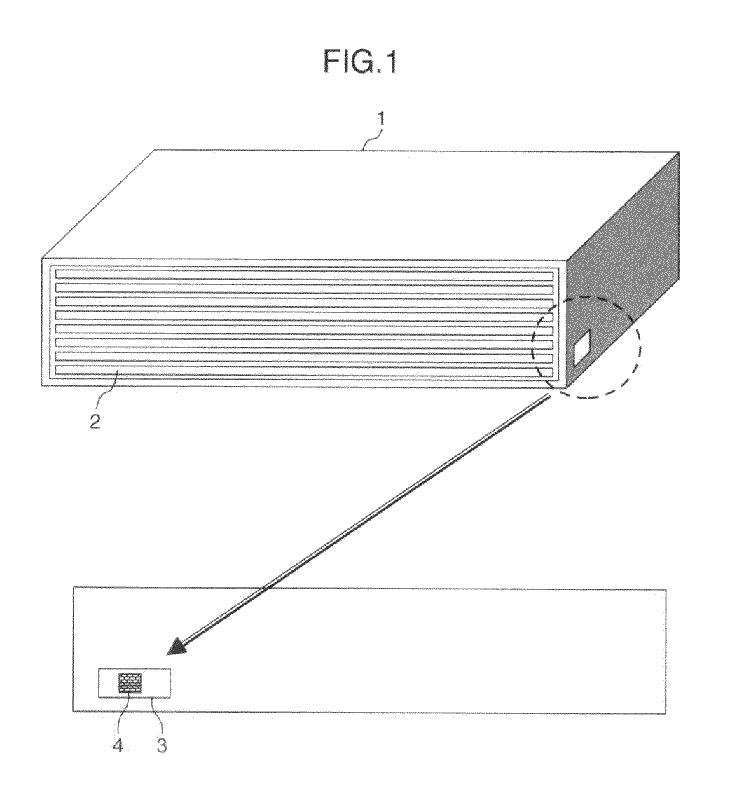

FIG. 1 is a view showing an external construction of an optical disk storage magazine according to the embodiment. As shown in FIG. 1, the magazine comprises a magazine case 1, of which a storage section can store a plurality of optical disks 2. Here, it is assumed that a write-once type optical disk having a preservation quality as archive file and producing an alteration preventive effect is used as the optical disk 2 but a rewritable type medium and a ROM medium can be of course used.

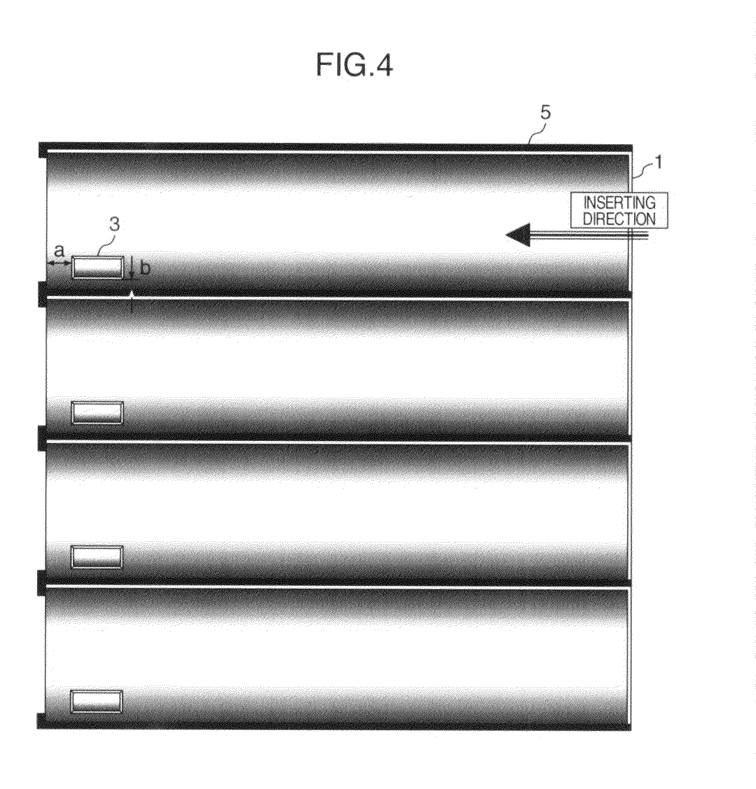

Also, an identification unit 4 for the recording of magazine management information (simply, referred below to as “management information”) is embedded in a side of the magazine case 1. For example, a RFID element can be used as the identification unit 4. The RFID element (indicated below as RFID element 4 in some cases) is one for communication based on electromagnetic coupling and capable of recording or reproducing operation without contact. The RFID element is advantageous in reliability as compared with a contact type identification unit and can be embedded physically to afford management made integral with a magazine. In addition, since a plurality of the magazines according to the embodiment are stacked in and mounted to an optical disk changer unit as a recording and reproducing unit as described later (FIG. 4), it is desirable to have the identification unit 4 operating in a limited range of communication. The reason for this is that a communication range must be limited so as to eliminate mutual interference in a method of use, in which a plurality of magazines are aligned and managed as shown in FIG. 4. Also, an optimum construction of a RFID element as used can be provided by the combination of communication in a relatively long wavelength and a small coil-shaped antenna. Use of, for example, Coil-On-Chip® manufactured by Hitachi Maxell Ltd. is effective.

Magazine management information recorded on the RFID element 4 includes, for example, identification numbers of magazine individuals, security information for prevention of alteration, information on how a plurality of optical disks stored in magazines are used, information (recorded file information as simplified) on what information is recorded on disks, hysteresis information of individual optical disks as included, time stamp, or the like. More specifically, used as management information are, for example, information to the effect that in the case where one hundred optical disks are stored in a magazine, 10th and 36th disks out of the one hundred disks are defective to be incapable of recording/reproducing (based on this, an operation can be carried out neglecting defective disks, or exchange of the disks can be made), information to the effect that information of a certain file is recorded up to midway a 12th disk (it is determined thereby that information can be again written from midway the 12th disk), information to the effect that which optical disk is pulled out from a magazine, and information to the effect that in the case where one file is recorded across a plurality of optical disks, which portion of the file is recorded on where on the disks, etc. Also, while cryptographic cord information for securing security for data is recorded on lead-in and lead-out of an ordinary optical disk, cryptographic cord information of information recorded on all optical disks in a magazine can be managed collectively when such cryptographic cord information is recorded on the RFID element 4.

Conventionally, in order to acquire the management information described above when preparing an operation for a magazine, access must be had to all optical disks in the magazine, and so it takes considerable time in acquiring the management information (since the management information is managed in optical disk unit). However, by recording the management information described above on the RFID element 4, it is possible to simply manage a plurality of optical disks in magazine unit, and further since it is not necessary to have access to optical disks one by one to acquire the management information, time for preparing recording/reproducing operations for a magazine can be shortened sharply. In addition, it suffices to record initial management information on a RFID element in, for example, factories for manufacture of optical disks and magazines.

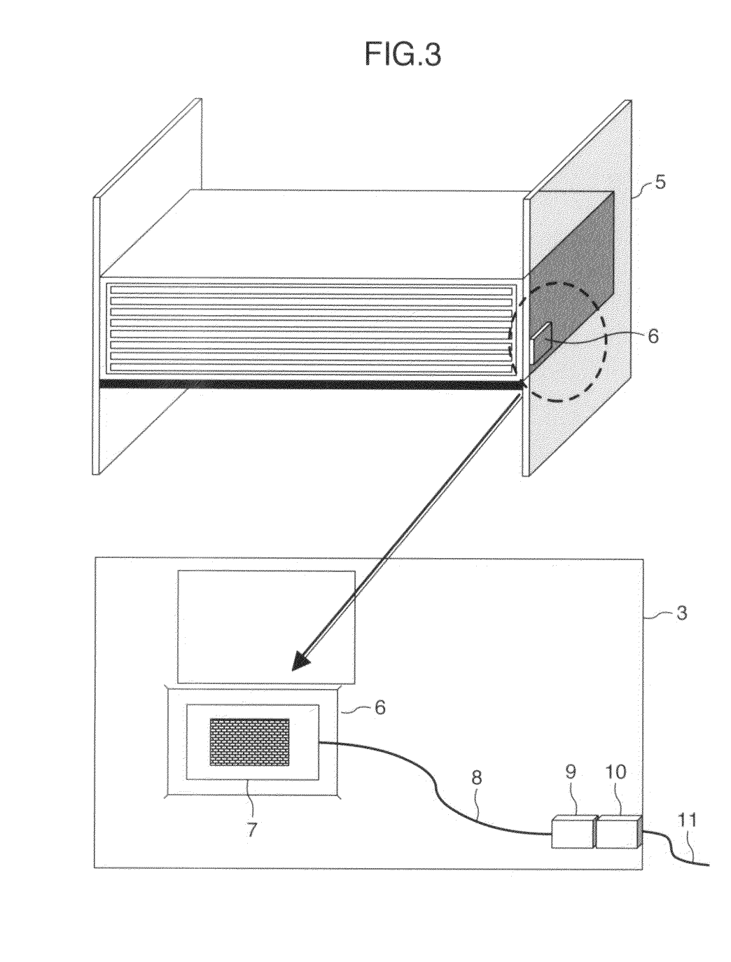

The identification unit 4 composed of a RFID element is provided in, for example, a specific mount position 3 of the magazine shown in FIG. 1. While the mount position 3 can be disposed in various positions such as a position close to a corner on a side of the magazine, an upper surface of the magazine, or the like, it is essential that such position be convenient for positioning. The reason for this is that the relationship with an antenna element 7 for communication is important and the identification unit 4 and the antenna element 7 must be positioned to face each other. Such arrangement is shown in FIG. 3 and the construction of a read unit for the RFID element (identification unit) 4 will be described in the following section.

### <Construction of Read Unit for RFID Element (Identification Unit) 4>

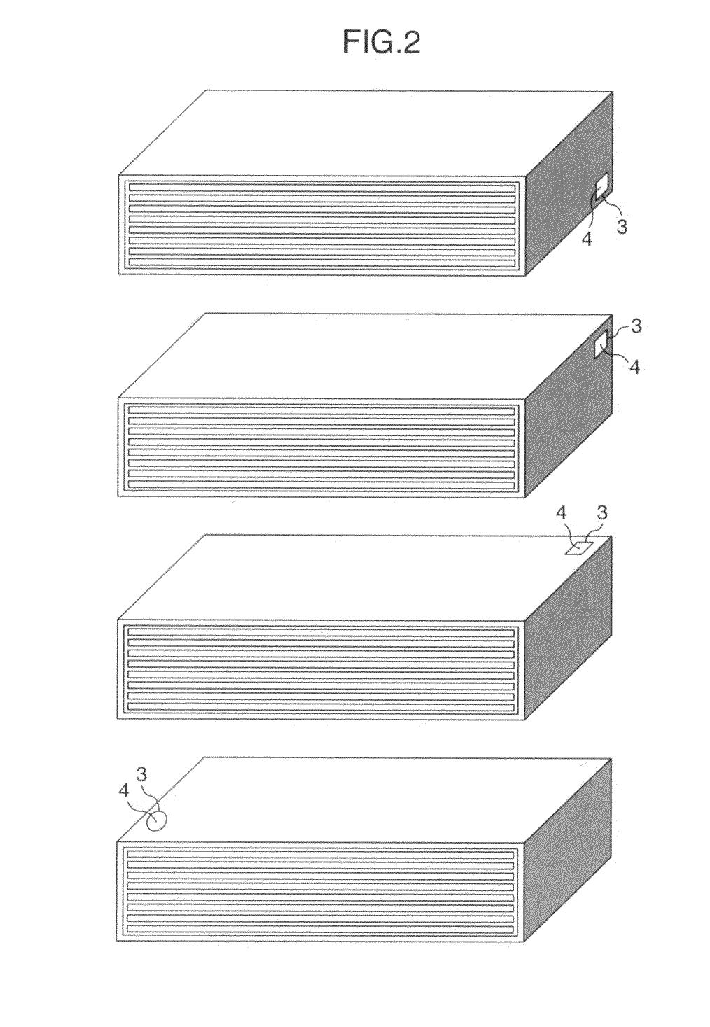

FIG. 3 shows the construction of a unit for reading the management information described above and included in the RFID element (identification unit) 4. In FIG. 3, the antenna element 7, which constitutes a read unit, is fixed to a magazine setting frame 5 of a changer device (not shown) by a fixation frame 6. In the case where the magazine is mounted on the magazine setting frame 5, it is required that the identification unit 4 incorporated in the magazine be disposed in the opposed relationship with the antenna element 7, and an arrangement for easy positioning is exemplarily illustrated in FIG. 2.

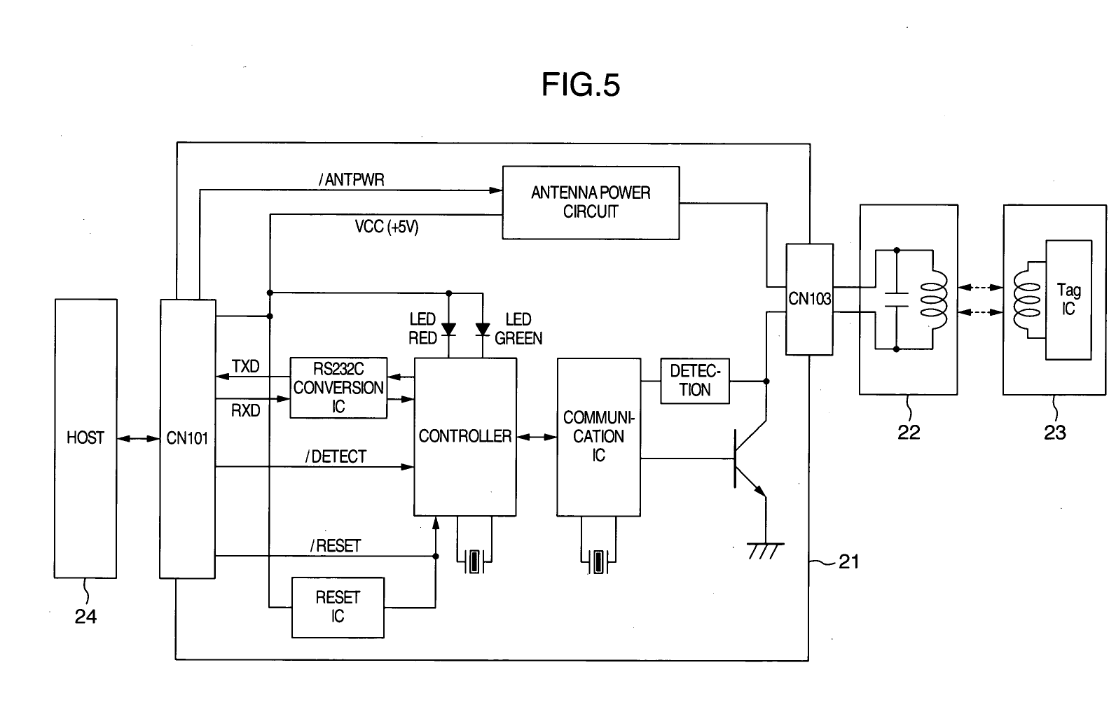

The antenna element 7 is connected to a reader/writer module 21 (FIG. 5) through a connector 9 and a connector 10 by a length of antenna cable 8.

### <Positioning of Magazine>

FIG. 4 is a view showing an example, in which the magazine is positioned. When the magazine (magazine case 1) is inserted into the magazine setting frame 5, the mount position 3 of the RFID element (identification unit) 4 provided on the side of the magazine case 1 comes to a specific position on one of magazine insertion shelves in the magazine setting frame 5 of the changer device. That is, as shown in FIG. 4, the mount position 3 is arranged in a position spaced a distance (a) from the inner part of one of the magazine insertion shelves and a distance (b) from a bottom surface (a position, which is in the vicinity of a position reference of the magazine and in which crosstalk with an antenna for the RFID element of an approximate magazine is not generated). The antenna element 7 provided on the magazine setting frame is also arranged in substantially the same position as the mount position. In the embodiment, the antenna element is made small in order to prevent generation of crosstalk.

In this manner, by setting the mount position 3 of the RFID element 4 in the vicinity (accuracy is mechanically easy to be made high) of a position reference of the magazine, fine displacement (fine play) in mounting of the magazine is made to have less influence on the RFID element. That is, the RFID element 4 is mounted in a position, which is in the vicinity of a position reference of the magazine and in which displacement in mounting of the magazine has no influence on the relationship opposed to the antenna element when the magazine is mounted to a disk changer system. In addition, while FIG. 4 shows a manner, in which four magazines are mounted, there is no restriction in number and setting is also possible in an arrangement in a longitudinal direction, or in a transverse direction, or in a combination thereof.

### <Construction of RFID System>

FIG. 5 is a view showing an example of an outline construction of a RFID system including the identification unit 4 and its read/write unit. The identification unit 4 includes a coil and is constituted as a tag 23 in FIG. 5. The antenna element 7 for communication with the tag 23 is constituted as an antenna module 22 including a capacitor for resonance, etc. The antenna module 22 and the reader/writer module 21 are connected to each other by a length of coaxial cable, etc. Further, the reader/writer module 21 is connected to a host 24 by a bus interface. For example, RS232C and USB are used as the bus interface.

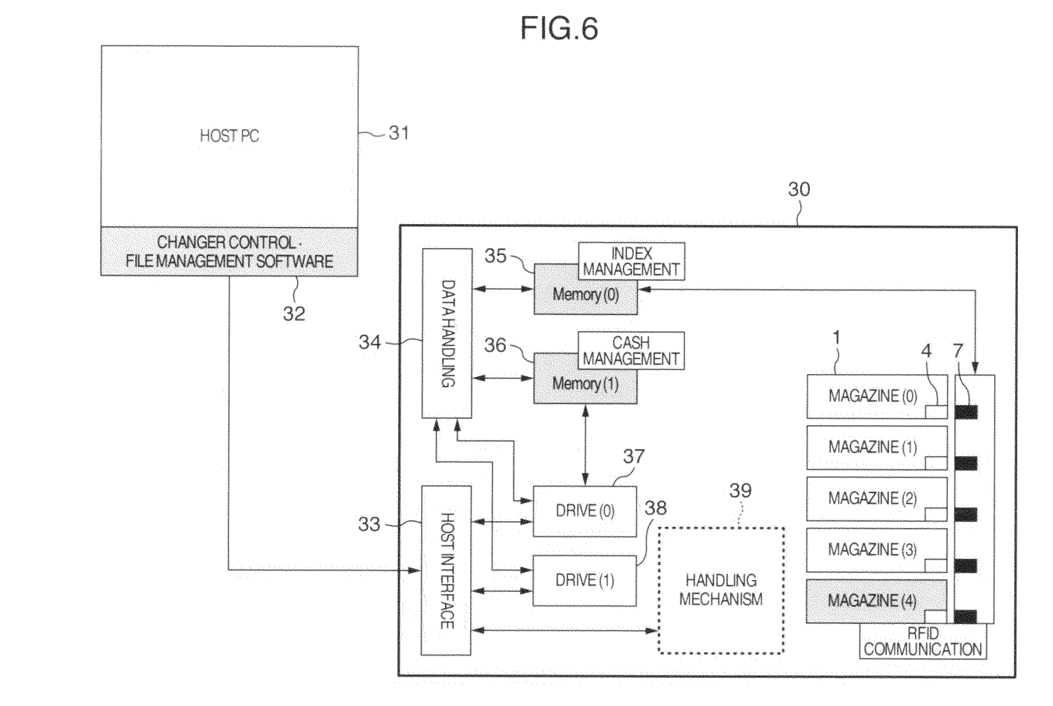

When data (management information) recorded on the RFID element (identification unit) 4 are to be read, or data are to be written thereon, an antenna power circuit feeds an electric current to an antenna section of the antenna module to carry out communication between the antenna section and the tag 23 (the RFID element 4). For example, in the case where information is read from the tag 23, a signal as read is detected by a detection circuit and thereafter the signal is converted into information to be transmitted to the changer unit and the host PC 24. Information as transmitted is stored in an Index management memory 35 (see FIG. 6).

### <Construction of Changer Unit>

FIG. 6 is a view showing an outline construction of a changer unit (disk changer system) 30, in which a plurality of magazines can be mounted. The changer unit 30 comprises a magazine shelf, in which a plurality of magazines are mounted, an antenna element group 7, through which information is read from an identification unit group 4 provided on the magazine case, the Index management memory 35, in which information as read is temporarily stored, a handling mechanism 39, by which an optical disk is taken out of a magazine and an optical disk taken into and used in a magazine is returned, drives 37, 38 for recording and reproducing of information from an optical disk, a data handling unit 34, by which information read from a disk is transmitted to a host PC 31 through a host interface 33 and which receives information being recorded in a disk from the host PC through the host interface 33 to process the same, and a Cash management memory 36. Also, the changer unit 30 is connected to the host PC to be controlled in various operations by changer control software in the host PC.

In FIG. 6, the magazine cases (magazine) 1, respectively, house therein a plurality of disks. The identification units 4 are mounted in the magazine cases 1 and the antenna elements 7 are arranged in opposition to the identification units as described above, so that information obtained through communication from the respective antenna elements and stored in the identification units 4 is recorded in the Index management memory 35. The memory serves to temporarily record information and collectively manages management information including attributes of magazines in the changer. Data handling in the changer is carried out by the data handling unit 34 on the basis of magazine information recorded in the Index management memory 35.

On the other hand, optical disk drives 37, 38 select a single optical disk from a plurality of disks in the magazines and the handling mechanism 39 loads the optical disk. The changer unit 30 includes a plurality of drives to enable driving different optical disks at a time. When a drive records and reproduces data, a data processing speed can be increased with the use of a Cash memory. The Cash management memory 36 functions for the purpose of an increase in recording/reproducing speed.

Data of the drives and the management memory are processed by the data handling unit 34 to be fed to the host PC 31 through the host interface 33. Changer control/file management software (simply, referred below to as “management system”) 32 works in the host PC to control an operation (including file management, etc.) of the changer unit 30.

### <Details of Operation Example of Changer Unit>

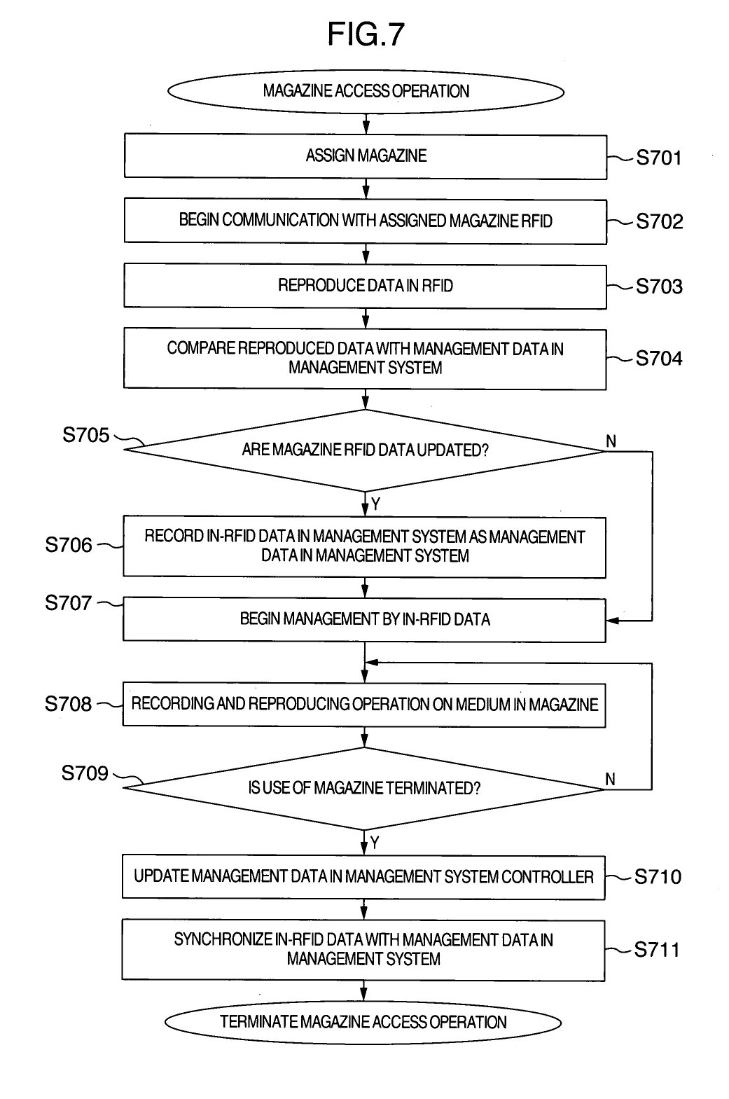

FIG. 7 is a flowchart for illustration of a magazine access operation as an operation example in the changer unit 30. In addition, unless especially specified, control entities in respective steps comprise a control unit (including changer control/file management software) (not shown) such as the host PC, etc.

In STEP S701, a magazine is first assigned. Specifically, the changer control/file management software 32 assigns a magazine according to file assignment by, for example, a user. The changer control/file management software 32 manages a magazine, in which an optical disk with information (file) recorded therein is included, such that when a file is assigned, a magazine number being a physical address and an optical disk are assigned and an optical disk being a relevant recording medium is selected.

In STEP S702, selection of an optical disk is carried out by scanning a magazine being relevant, or assigning a specific magazine set frame address to communicate with the RFID element 4, which is included in the magazine. Management information on the magazine is recorded on the RFID element 4 and the management information is reproduced in STEP S703.

In STEP S704, the reproduced management information is compared with magazine management information (recorded in the Index management memory 35), which is managed by the changer control/file management software 32. In STEP S705, whether data are correct (whether both data agree with each other) is verified, and in the case where data are correct (both data agree with each other), it is unnecessary to update management information in the management system and the RFID element 4, so that the procedure shifts to STEP S707. On the other hand, in the case where it is determined in STEP S705 that data are not correct, the procedure shifts to STEP S706 in order to update management information. The processing of comparison described above is one for elimination of an altered magazine, and serves to update data in that RFID element 4, which is broken due to some reason, or to update management data in the management system in the host.

In STEP S706, that processing, in which data (magazine management information) in the RFID element 4 are recorded (updated) as management data in the management system, is carried out. That is, in the case where time stamps are the same but compared data do not agree with each other, there is a possibility that either of data undergoes data error and so it is possible to revise the error with an error detection flag. In STEP S707, data in the RFID element 4 (magazine management information read from the RFID element 4) are fundamentally handled as data for magazine management.

Further, the procedure shifts to STEP S708, in which the optical disk drive performs a recording/reproducing operation on an optical disk selected in a magazine. In STEP S709, it is determined whether the recording/reproducing operation is terminated and use of the magazine is terminated, and when termination is not yet, the recording/reproducing processing is continued. When it is determined that use of the magazine is terminated, the procedure shifts to STEP S710.

In STEP S710, management information in the management system is updated. That is, in the case where information stored in an optical disk being an object is changed by the recording/reproducing operation performed in STEP S708, the changer control/file management software 32 updates magazine management information recorded in the Index management memory 35 to reflect the contents as changed.

In STEP S711, when an optical disk after the termination of recording/reproducing is returned to a predetermined position in a magazine, the changer unit 30 communicates with the RFID element 4 through the antenna element 7 whereby management information recorded in the RFID element 4 is updated by magazine management information recorded in the Index management memory 35. When management information is updated, management information in the RFID element 4 and management information in the management system are synchronized with each other and simultaneously therewith time stamps are recorded in the RFID element 4. In addition, the Index management memory 35 functions without having influences on the whole function of the host PC 31.

### <Summary>

File data are recorded in a plurality of disks in the magazines according to volume setting by the file management software, so that individual management every optical disk is difficult. Therefore, management with a magazine, which includes a plurality of optical disks, as a unit is needed.

According to the embodiment of the invention, a magazine, which accommodates and stores a plurality of optical disks in one and the same magazine, and a recording unit, which records management information on hysteresis and inherent information of optical disks accommodated in the magazine, are constructed to be made integral together. By doing this, disks set in volume are media-managed as a body and so can be used as a single large capacity optical medium (capacity made to volume). Accordingly, a user enables use as a large capacity recording medium and it is possible to construct a recording medium system being very convenient in use.

Also, according to the embodiment of the invention, a changer system, in which a plurality of magazines each accommodating and storing a plurality of optical disks in one and the same magazine are arranged, comprises recording units (RFID elements), in which management information of optical disks accommodated in the magazines is recorded, a recording medium used in the recording unit is constructed to be made integral with a magazine, and magazines are arranged in predetermined positions (mounted to the changer unit) whereby management information on the magazines is communicated between a communication terminal provided on the changer unit and the recording units, and the changer unit recognizes the magazines as inherent magazines to get management information of optical disks accommodated in the magazines to exercise control on a recording/reproducing operation. In this manner, by providing an identifier inherent in a magazine as management information, it is possible to correspondingly relate the contents of information recorded in a magazine and a changer management address to each other. An identifier inherent in a magazine has unique contents and so determination of the identifier makes it possible to rapidly perform information retrieval. Also, management information is transmitted by communication to magazines with a communication terminal provided on a part of a shelf, on which magazines are arranged, and can be recognized as information, in which an inherent address set on the shelf and inherent addresses of the magazines are related to each other. In this manner, it is possible to provide a changer unit, which supports associated operations, as a unit.

1. A disk magazine accommodating therein a plurality of disks having a thickness of 0.3 mm or less and constructed to be made integral with a recording unit, in which management information including hysteresis information and inherent information of disks accommodated in the disk magazine is recorded,
the management information including, as inherent information of disks, information of a defective disk, or information of a disk pulled out from the disk magazine to be missed.

2. The disk magazine according to claim 1, wherein the recording unit comprises a semiconductor memory.

3. The disk magazine according to claim 2, wherein a recording or reproducing operation of the management information is performed on the recording unit through radio communication.

4. The disk magazine according to claim 1, wherein the management information includes information on a file, which is recorded across a plurality of disks.

5. The disk magazine according to claim 1, wherein the management information includes, as inherent information of the disks, information of a defective disk, or information of a disk pulled out from the disk magazine to be missed.

6. A disk changer system in which a disk magazine accommodating a plurality of disks, wherein a disk is taken out from the disk magazine and a recording/reproducing operation of information is carried out,
the disk changer system comprising management information acquisition means for communication with a recording unit, in which management information of the plurality of disks accommodated in the disk magazine is recorded, to acquire the management information, and
processing control means, which specifies the disk magazine on the basis of the management information acquired by the management information acquisition means and controls a recording/reproducing operation for disks accommodated in the disk magazine, and
wherein the recording unit is integrally mounted with the disk magazine.

7. The disk changer system according to claim 6, further comprising a plurality of shelves capable of mounting thereon a plurality of disk magazines, and
wherein the management information acquisition means includes communication means provided on each of the plurality of shelves to communicate with a recording unit provided on the plurality of disk magazines, and relates an inherent address of a disk magazine included in the recording unit and an inherent address of a shelf set for each of the plurality of shelves to each other to recognize the plurality of disk magazines.

8. The disk changer system according to claim 6, wherein the communication means comprises radio communication means composed of a non-contact semiconductor element and is put in an opposed relationship with the recording unit when the disk magazine is mounted.

9. The disk changer system according to claim 8, wherein the recording unit is mounted in the vicinity of a position reference of the disk magazine and in that position, in which shift in mounting of the disk magazine has no influences on the opposed relationship with the radio communication means when the disk magazine is mounted to the disk changer system.

10. The disk changer system according to claim 6, wherein the management information, as inherent information of disks, information of a defective disk, or information of a disk pulled out from the disk magazine to be missed.

11. The disk changer system according to claim 6, wherein the communication means comprises radio communication means composed of a non-contact semiconductor element and is put in an opposed relationship with the recording unit when the disk magazine is mounted.

12. A disk changer system in which disk magazines each accommodating a plurality of disks, wherein a disk is taken out from the disk magazine and a recording/reproducing operation of information is carried out,
the disk changer system comprising a plurality of shelves for mounting thereon a plurality of disk magazines,
management information acquisition means for communication with a recording unit, in which management information of a plurality of disks accommodated in the disk magazine is recorded, to acquire the management information, and
processing control means, which specifies the disk magazine on the basis of the management information acquired by the management information acquisition means and controls a recording/reproducing operation for disks accommodated in the disk magazine, and
wherein the management information acquisition means includes communication means provided on each of the plurality of shelves to communicate with a recording unit provided on the plurality of disk magazines, and relates an inherent address of a disk magazine included in the recording unit and an inherent address of a shelf set for each of the plurality of shelves to each other to recognize the plurality of disk magazines.
